(19) United States
(12) Patent Application Publication
(10) Pub. No.: US 2022/0120399 A1
(43) Pub. Date: Apr. 21, 2022

(54) CONTINUOUS LIGHTING SYSTEM FOR ROAD TUNNELS

(71) Applicant: SACYR CONCESIONES S.L., Madrid (ES)

(72) Inventor: Daniel Castillo Recatala, Casabermeja (ES)

(73) Assignee: SACYR CONCESIONES S.L., Madrid (ES)

(21) Appl. No.: 17/431,423

(22) PCT Filed: Feb. 6, 2020
(86) PCT No.: PCT/ES2020/070082

§ 371 Date: Aug. 16, 2021

(30) Foreign Application Priority Data
Feb. 15, 2019 (ES) P201930117

(51) Int. Cl. F21S 8/08; F21V 23/00; F21V 5/04

(52) U.S. Cl. CPC F21S 8/086; F21Y 2115/10; F21V 5/04; F21V 23/004

(57) ABSTRACT

Continuous lighting system for tunnels having a plurality of luminaires or lighting devices (1), comprising a longitudinal base (2) having means for securing to the tunnel, a transparent or translucent closure element (3), at least one PCB (4), and a plurality of consecutive LED light sources (5), connected to said PCB (4), forming at least one row with separation between them such that the angle of emission (AE) in the longitudinal direction of the tunnel permits a continuity of consecutive light rays, wherein the separation between LEDs (5) depends upon the height of the lighting device (1), and wherein the means of securing a base (2) to the tunnel comprise means of adjustment of an angle of inclination (AI) according to the transverse direction of the tunnel, such that the combination thereof with the angle of emission permits a lighting uniformity approaching 100%.

### TECHNICAL FIELD OF THE INVENTION

The present invention corresponds to the technical field of the lighting systems of road tunnels, in particular to a continuous lighting system for the same.

### BACKGROUND OF THE INVENTION

There exists at the present time wide experience in the design of lighting for tunnels and, in particular, for stretches of tunnels presenting particular requirements by virtue of the fact that they include dark points or zones within the alignment to be travelled along by the driver.

The principal problem generated is due to the high contrast between the low lighting existing within the interior of the tunnels and the high external luminances during the day, producing problems of visibility by virtue of the difficulties of adaptation of the human eye.

This problem occurs at the entrance of the tunnel by virtue of the fact that the eyes of drivers are adapted to the high natural lighting existing in the exterior and a particular distribution of luminances may occasion the known black hole effect, preventing drivers seeing within the interior of the tunnel when they are at a given distance from the mouth of the same.

Furthermore, at the exit of the tunnel the contrary effect is generated by virtue of the contrast between the low interior lighting and the high exterior lighting, occasioning dazzle, reducing the capacity of response of the driver until the eyes thereof become habituated to the new level of exterior luminance.

Given that the visual adaptation of the human eye is progressive and requires a certain time, the lighting within the interior of tunnels is divided into zones denominated threshold, transition, interior and exit, the length whereof depends on the speed of the road and the length of the tunnel.

Each of these zones requires levels of lighting varying as a function of the lighting conditions exterior to the tunnel. The length of the transition zone and that of the exit zone, in the same manner as occurs with the transition zone, is normally much shorter than that of the interior zone nevertheless, by virtue of the diurnal lighting requirements thereof, these zones present energy consumptions representing the majority of the energy consumption of the tunnel in spite of the shorter length thereof.

In addition to the requirement of the level of luminance other factors must be taken into account, such as a uniformity in the lighting, avoiding zebra effects and dark zones, a distribution of the points of light such as to not generate a flicker effect, consisting in pulsing due to the cyclic variations of the luminance in the field of vision, nor a Purkinje effect, by virtue of the change in the form of vision of the eye.

The systems of tunnel lighting generally comprise permanent illumination, switched on all the time along the entire length of tunnel, and reinforcement illumination, switched on during the day, solely in the threshold and exit zones.

These forms of lighting generate high electrical consumption, both from the permanent lighting, switched on during the entire day, and from the reinforcement lighting, representing a high additional power.

Sodium vapor lamps have generally been utilized in the lighting of tunnels by virtue of the high luminous efficacy thereof, being greater the higher the power consumed by the same. The utilization of luminaires of higher power permits a greater separation between the same, however this separation must be controlled by virtue of the fact that if they are excessively separated the aforementioned zebra effect, or lack of longitudinal uniformity, is generated.

The appearance of LED technology offers the possibility of utilization of luminaires of high efficacy at lower prices, resulting in a great advantage given the high consumption by lighting in tunnels.

In addition, lighting on the basis of LEDs produces other advantages, such as a longer useful life and, consequently, a saving in maintenance, less reduction in performance with time of use, together with the possible selection of the color temperature and the regulation of the consumption in conformity with the lighting requirements.

However, in spite of all these possible advantages, at the present time the utilization of LED technology in the lighting of tunnels has not been implemented as was to be expected and has simply been limited to the manufacture of light fittings for tunnels, similar to those in existence of sodium vapor but with LEDs.

This has not meant a great advantage in relation to that already in existence by virtue of the fact that the most advanced LEDs have a luminous efficacy similar to the 400 W high pressure sodium vapor lamps. For this reason the majority of the studies on changing to LEDs have been limited to permanent lighting where a small advantage in luminous efficacy may indeed be achieved in comparison with the HPSV (high pressure sodium vapor) light fittings of 150 W or 250 W, these normally being distributed at distances of between 20 and 30 meters.

Nevertheless, it makes no sense to undertake the study for the reinforcement lighting, and the savings produced in the permanent lighting are so small that the return on the investment required to change the existing HPSV light fittings for others of LEDs is questionable.

As an example of the state of the art there may be mentioned the reference document CN102374452 revealing the employment of LED light fittings of between 80 and 200 W and including diverse tables presenting the results of luminances obtained through these light sources in the different stretches to be considered in the lighting of a tunnel. In said document the advantages are set out of the useful life of the LED lamps in comparison with other technologies (fluorescent, metal halide, HPSV, etc), the additional advantages in view of a better control of the level of lighting as a function of the exterior characteristics, and the advantage that it is a matter of directional and not disperse sources (voluminous lamps which distribute the light in all directions).

The high color rendering index (CRI) in comparison with other sources, such as the sodium vapor lamps, is also set out. All these circumstances signify that a system of lighting of tunnels with LEDs is economically more sensible and leads to an improvement in safety.

However, in this document no improvement is set out in regard to the utilization of LEDs, these permitting obtaining a great uniformity in the lighting of the tunnel, approaching 100%, by means of the employment of points of light of low power distributed at small distances. Nor does it set out taking advantage of the possible directionality of the LEDs.

As an improvement to this approach the applicant is the owner of a reference document WO2018065651 wherein there is set out a system of lighting based upon the employment of small LED lights, instead of large lamps, in order to achieve a uniformity approaching 100% and taking advantage of the possibility offered by the LEDs of realizing this distribution with points of low power, at the same time with precision, directing the light to the carriageway and the surroundings requiring to be lit (such as hard shoulders and sidewalks) in a precise manner and without any wastage.

Differing from that set out in the document CN102374452, wherein solely the angle of inclination, in the transverse sense of the tunnel, of the light fittings is considered, in the document WO2018065651, in order to achieve a uniformity approaching 100%, the light emitting devices are provided with closure lenses rendering possible a predetermined angle of emission of the light rays in the longitudinal sense.

Consequently, with the new system set out in the document WO2018065651 the employment is not sought of LED light fittings of greater power having the sole objective of being able to replace those of other technologies (principally high pressure sodium vapor) at spacings similar to those currently employed with this technology, that is to say that what is not sought is to replace an existing system of lighting by another having luminaires with LEDs situated at the same points but what is sought is to achieve a totally new system having a continuous distribution of small points of light.

However, the most recent research by the applicant has lead to the conclusion that this new system set out may be improved in certain aspects, by virtue of the fact that being formed by multiple luminaires, each whereof constituted by a LED secured to the tunnel and having its individual closure lens, requires a more complicated and slower installation than if the installation is considered of an assembly of lighting devices or luminaires incorporating a plurality of LED light sources in a combined manner.

In addition, the greater the separation between luminaires the greater is the requirement for the higher power of the same in order to be able to cover with the light rays thereof the area object of lighting between both, preventing shadow zones, having the outcome that through greater power a lower useful life is obtained.

Furthermore, given that each luminaire is secured in an independent manner to the tunnel, means of anchorage for each of said luminaires is required, this being costly, both financially and in terms of installation time and labor employed.

Consequently, it will be necessary to find a new system permitting the resolution of these disadvantages, maintaining a longitudinal uniformity in the lighting of the tunnel approaching 100%.

### DESCRIPTION OF THE INVENTION

The continuous lighting system for road tunnels, herein presented, comprises a plurality of lighting devices or luminaries secured within the interior of the tunnel. These lighting devices are disposed in a consecutive manner and separated one from another by a distance shorter than that corresponding to the flicker frequency for the speed of traffic corresponding to the tunnel.

Each of the light devices comprises a longitudinal base presenting means of securing to the interior of the tunnel, a transparent or translucent closure element presenting first means of securing to said base, the length whereof being equal to the same, at least one printed circuit board (PCB) disposed within the interior of the light device, secured to the base and connected to an electrical supply network through means of connection, and a plurality of LED light sources, connected to said PCB, such that each PCB constitutes the means of securing and the supply circuits of a plurality of LED light sources. These LED light sources are disposed forming at least one row in the sense of the longitudinal direction of the PCB.

Said LED light sources present a separation distance from one another such that the angle of emission of light rays over an object area in the longitudinal direction of the tunnel permits a continuity of the same for each pair of consecutive light sources in a single row, wherein the value of the separation distance between light sources depends upon the positioning height of the lighting device.

In respect of the means of securing the base to the interior of the tunnel, the latter comprise means of adjustment of an angle of inclination of the light ray in the sense of the transverse direction of the tunnel, such that the adjustment of the angles of emission and of inclination permits a lighting of the object area presenting a longitudinal uniformity approaching 100%.

A significant improvement in the state of the art is obtained through the continuous lighting system for road tunnels herein proposed.

Consequently, in this manner a system of continuous lighting is obtained wherein each lighting device comprises a plurality of LED light sources, of those said luminaire may possibly contain, connected to a PCB. Differing from other systems, wherein each LED light source constitutes an independent lighting device having an individual lens closure thereof, in this proposed system each lighting device contains multiple light sources, in this case of a LED nature, together with means of securing the device to the tunnel as an assembly and not each LED light source separately. All this permits greater simplicity in the assembly and installation of the lighting system, having the impact of a significant reduction in times and costs of said items and the labor required to be employed.

Furthermore, in terms of the electrical connection, each of the LED light sources is connected to a PCB, and it is said PCB which is connected to the supply network, avoiding the existence of multiple connections, consequently achieving facilitating the installation and the material and labor costs.

In addition, this system presents the advantage that a sensation of continuous lighting is offered by virtue of said proximity between the LED light sources.

Moreover there is also considered in this system the possibility, should this be understood to be necessary, of being enabled to utilize a plurality of orientation elements and optical elements, such as lenses or reflectors, each associated with one or several LED light sources, such that a lighting having the desired photometry is obtained, both symmetrical and asymmetrical in the transverse and longitudinal planes.

This lighting system, through the adjustment of the angle of inclination in combination with the angle of emission, permits a lighting of the object area having a longitudinal uniformity approaching 100%, resulting in a very efficacious system, simple to install, presenting shorter times and lower costs, and having very favorable outcomes in respect of the durability and performance of the LED light sources, this being translated into less repair and conservation work.

### BRIEF DESCRIPTION OF THE DRAWINGS

Having the objective of assisting towards a better comprehension of the characteristics of the invention, in conformity with a preferential example of practical embodiment of the same, as an integral part of said description there is provided a series of drawings wherein, in an illustrative and non-limitative manner, the following has been shown:

FIG. 1 shows a perspective view of a lighting device of a continuous lighting system for road tunnels, for a first form of preferential embodiment of the invention.

FIGS. 2.1 and 2.2 show longitudinal and transverse cross-sections of a lighting device of a continuous lighting system for road tunnels, for a first form of preferential embodiment of the invention.

FIG. 3 shows an elevation view of the means of securing the base to the interior of the tunnel, for a first form of preferential embodiment of the invention.

FIG. 4 shows a perspective view of the means of securing the base to the interior of the tunnel, having a particular angle of inclination, for a first form of preferential embodiment of the invention.

FIG. 5 shows a perspective view of a tunnel having a continuous lighting system for road tunnels, for a first form of preferential embodiment of the invention.

FIG. 6 shows a perspective view of the lighting devices of a continuous lighting system for road tunnels, for a second form of preferential embodiment of the invention.

FIG. 7 shows a cross-sectional view of the continuous lighting device for road tunnels, for a second form of preferential embodiment of the invention.

FIG. 8 shows a perspective view of the continuous lighting device for road tunnels, having the lateral closure, for a second form of preferential embodiment of the invention.

FIG. 9 shows a perspective view of the continuous lighting device for road tunnels, having the lateral closure and the connection to the means of supply of current, for a second form of preferential embodiment of the invention.

### DETAILED DESCRIPTION OF A FORM OF PREFERENTIAL EMBODIMENT OF THE INVENTION

By virtue of the figures provided it may be observed how, in a first form of preferential embodiment of the invention, the continuous lighting system for road tunnels, proposed herein, comprises a plurality of luminaires or lighting devices (1) secured within the interior of the tunnel.

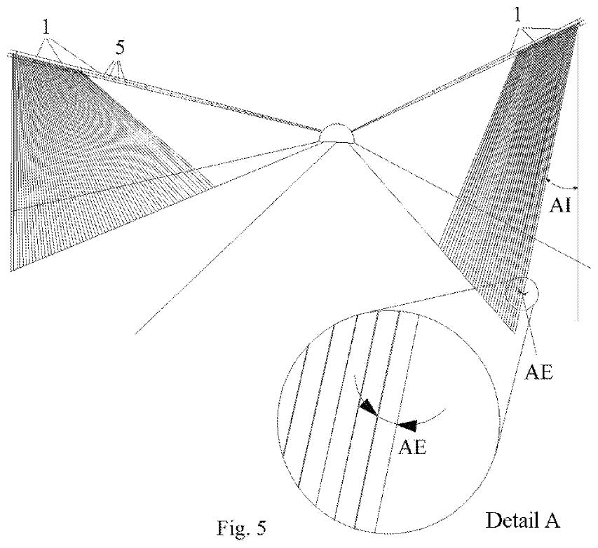

As is shown in FIG. 5, in this first form of preferential embodiment of the invention, the luminaires or lighting devices (1) are in this case secured upon the wall of the tunnel at a height which may be comprised between 20 cm and 5 m and present an appearance of continuous lighting. Nevertheless, in other forms of embodiment they may be secured upon the roof of the same.

In said FIG. 5 it may also be observed that the luminaires or lighting devices (1) are disposed in a consecutive manner and separated by a distance shorter than that of the flicker frequency for the speed of traffic corresponding to the tunnel. In this form of preferential embodiment of the invention they are disposed in the sense of the longitudinal direction of the tunnel, in this case the speed of the tunnel being 100 km/h and the flicker frequency 15 Hz, said distance must be less than 1.85 m.

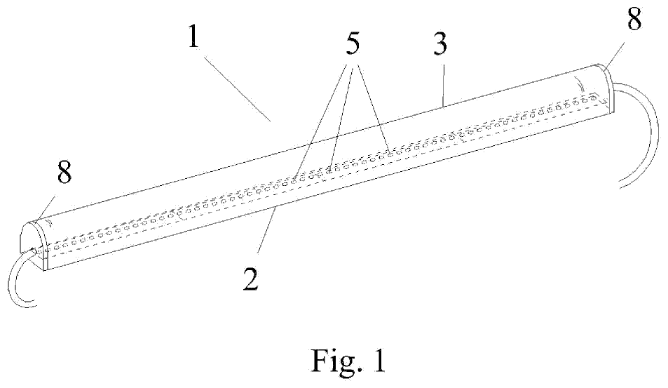

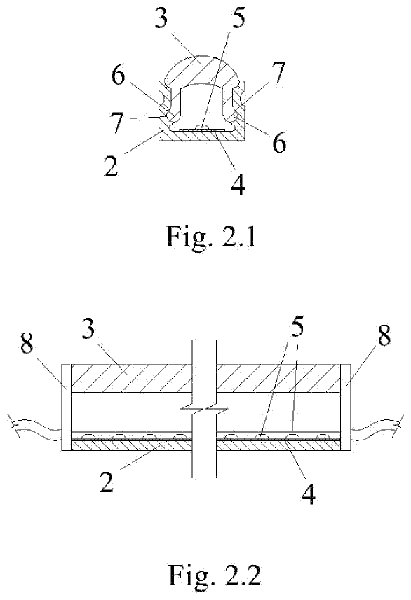

Furthermore, as is shown in FIGS. 1, 2.1 and 2.2, each of the luminaires or lighting devices (1) comprises a longitudinal base (2), in this first form of embodiment, formed by a longitudinal extrusion of aluminum, however in other forms of embodiment it may be a part of aluminum or of another material formed by casting or press forming, or of ribbed plate. This base (2) additionally presents means of securing to the interior of the tunnel.

The lighting device (1) or luminaire in turn comprises a transparent or translucent closure element (3) presenting means of securing to said base (2), the length whereof is equal to the length of the same, at least one printed circuit board (PCB) (4) disposed within the interior of the lighting device (1), secured to the base (2) and connected to an electrical supply network through means of connection, and a plurality of LED light sources (5), connected to said PCB (4) and disposed forming at least one row in the sense of the longitudinal direction of the PCB. As is shown in FIG. 1, in this first form of preferential embodiment of the invention the plurality of LED light sources (5) are disposed forming a single row.

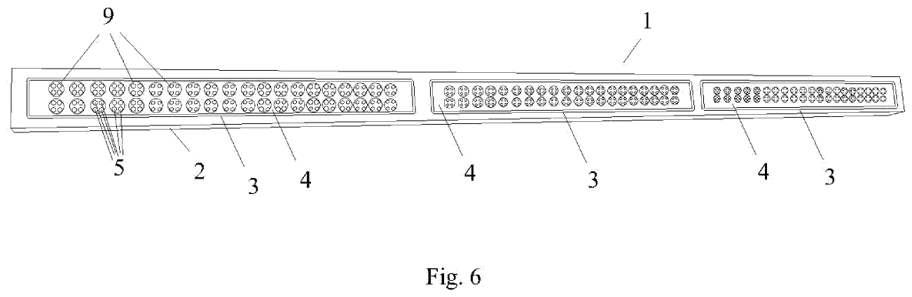

However, in other forms of embodiment there may be formed 2, 3, or the required number of rows, as shown in FIG. 6, wherein there is shown a second form of embodiment wherein the LED light sources (5) are disposed forming two rows in the sense of the longitudinal direction of the PCB (4).

These LED light sources (5) present a separation distance therebetween such that the angle of emission (AE) of light rays upon an object area in the longitudinal direction of the tunnel permits a continuity of the same for each pair of consecutive LED light sources (5), as shown in detail A of FIG. 5. The value of said separation distance between LEDs (5) depends on the positioning height of the lighting device (1), which may be comprised between 20 cm and 5 m, according to the particular conditions of the tunnel to be illuminated.

In FIG. 5 there are solely shown the light rays of the LED light sources (5) of two luminaires or lighting devices (1) on both sides of the carriageway (in order to not overload the figure with the lines corresponding to the rays of all the LEDs) being sufficient such as to be able to observe the sensation of continuity of said light rays upon the carriageway. Said continuity may be appreciated in detail A of FIG. 5, wherein the proximity of the light rays is shown, and this continuity is practically complete from the position of the LEDs (5) wherefrom emerge the light rays to the carriageway, as shown in FIG. 5, the small separation existing in the highest zone, whereat the LED light sources (5) are located, being inappreciable to the human eye. This is the reason for the sensation of continuity achieved through this solution.

Furthermore, the means of securing the base (2) to the interior of the tunnel comprise means of adjustment of an angle of inclination (AI) of the light ray in the sense of the transverse direction of the tunnel, such that the adjustment of the angles of emission and of inclination (AE, AI) permits a lighting of the object area having a longitudinal uniformity approaching 100%.

The object area of this form of embodiment is a carriageway, however in other forms of embodiment it may be a part of the same.

In this form of preferential embodiment of the invention the base (2) of the lighting device (1), formed by an aluminum extrusion, presents a length of 2 m. However, in other forms of embodiment, as a function of the length of the tunnel, extrusions having different lengths may be utilized, such lengths being comprised within a range from 20 cm to 3 m.

In this first form of preferential embodiment of the invention the transparent or translucent closure element (3) is itself formed by a lens having optical functionality disposed over a plurality of LED light sources (5). Consequently, in this case the lens is longitudinal and presents the same length as the base (2) whereunto it is secured.

However, in other forms of realization, the lighting device (1) may comprise within the interior thereof at least one lens (9) having optical functionality disposed over at least one LED light source (5), presenting second means of securing to the base (2).

This is the case of the second form of preferential embodiment of the invention represented in FIG. 6 wherein, as may be observed, the luminaire or lighting device (1) comprises three PCBs (4) presenting, connected to the same, a plurality of LED light sources (5). In this manner, over said LED light sources (5) there exist lenses (9) having optical functionality such that each lens (9) is disposed, in this example, over four LED light sources (5) and over all these lenses (9) there exists the transparent or translucent closure element (3).

In addition, in this second form of preferential embodiment of the invention, at least one of the lenses (9) presents an optical functionality differing from that of the remaining lenses (9) such that, through the differing optical functionality of these lenses (9), the desired photometry may be obtained in each specific case.

In the first form of embodiment, wherein the lens is longitudinal and coincident with the closure element (3), this latter is formed of polycarbonate, nevertheless any expert in the art will understand that other materials having similar characteristics may be utilized. For their part the first means of securing the closure element (3), coincident with the lens in this case, to the base (2) are formed by lateral clips (6) each suitable for interlocking into the same number of grooves (7) existing in the sides of the base (2), as shown in FIG. 2.1.

In the first form of preferential embodiment of the invention each luminaire or lighting device (1) comprises in the interior thereof four consecutive PCBs (4) having a thickness of 8 mm and a length of 497 mm. To each of the PCBs (4) there are connected 16 LED light sources (5), connected in series.

In other forms of embodiment, as a function of the length of the lighting device (1), there may exist a different number of PCBs (4) in the same, connected in parallel or in series. Similarly, according to the number of PCBs (4) and the length of the base (2), the length is determined of each of these PCBs (4), by virtue whereof the length of the same is variable and defined for each specific case.

In the same manner, each of the PCBs (4) may be connected to a variable number of LED light sources (5). In this first form of embodiment 16 LED light sources (5) are included distributed in a single row however, as aforestated, in other forms of embodiment such as, for example, the second form proposed, they may be distributed in two or more rows and the number of LEDs (5) connected to a single PCB (4) may vary.

Consequently, given that the maximum length of the base (2) of a luminaire or lighting device (1) is 3 m, in an extreme case and for a minimum spacing between LED light sources (5) of 0.5 cm, a lighting device (1) may contain up to 600 LEDs (5) connected to the PCBs (4) within the interior of the same. Furthermore, the total quantity of LED light sources (5) of the lighting device (1) is distributed between the PCBs (4) presented by the latter within the interior thereof, consequently, as a function of the number of PCBs (4), these latter comprise a greater or lesser number of LED light sources (5) connected to each thereof.

In this first form of preferential embodiment of the invention, the four PCBs (4) are connected in parallel and the longitudinal extremities of the base (2) present a lateral closure (8) of the lighting device (1) such that the extremity of the two PCBs (4) disposed in the extremities of the base (2), coincident with the corresponding extremity of the base (2), respectively comprise a connection to the source of supply, and the lateral closure (8) at both extremities of the base (2) presents a leadout element (not shown in the drawings) of the connection cable through the same. This lateral closure (8) is sealed with silicone to achieve the hermeticity of the lighting device (1).

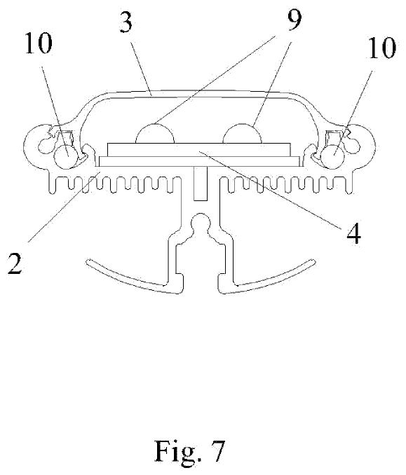

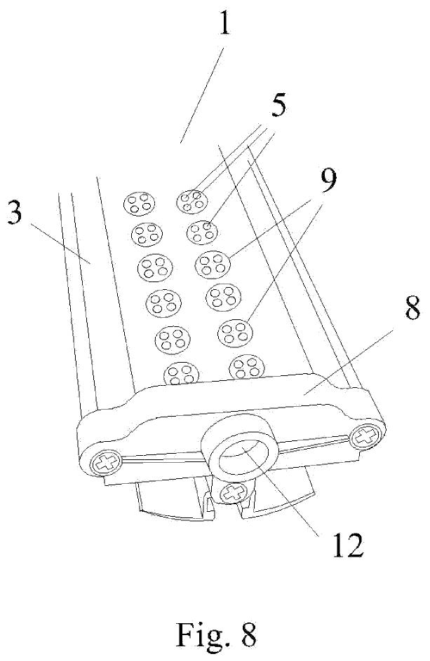

In FIG. 7 there is shown a cross-section of the lighting device (1) for a second form of preferential embodiment of the invention and, in respect of this cross-section, in FIG. 8 there may be observed the lateral closure (8) for this second form of proposed embodiment comprising hermeticity seals (10) of silicone between the lateral closure (8) and the base (2).

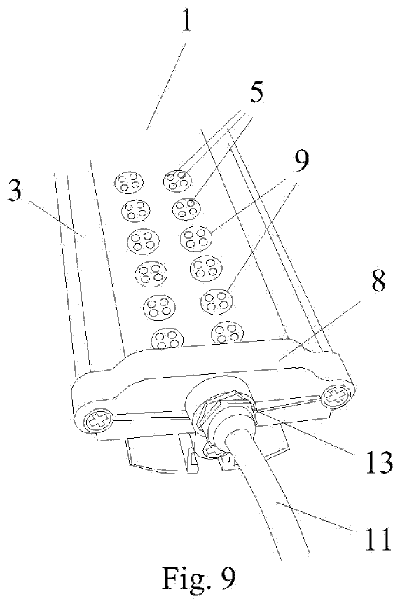

In addition, in order to facilitate the passage of the connection cable (11) to the means of supply, this lateral closure (8) presents in the leadout orifice (12) a leadout part (13), as may be observed in FIG. 9.

In the first form of preferential embodiment of the invention the means of connection of the at least one PCB (4) to the alternating current electrical supply network include means of supply of direct current to the same and means of regulating the current and/or the voltage of the direct current supplied to the LED light sources (5) comprising, in this case, a driver. In other forms of embodiment the system may comprise two or more drivers as a function of the characteristics of said system and of the number of devices of the same.

Consequently, the second proposed form of embodiment is an example of a lighting system comprising more than one driver and, in this case, the LED light sources (5) of a lighting device (1) are connected to at least two drivers disposed in parallel.

In this manner, in this second form of embodiment, shown in FIG. 6, the LED light sources (5) of a lighting device (1) are configured according to at least two groups wherein each of these groups is supplied by a different electrical circuit. As a consequence, this design is particularly useful for the utilization thereof in reinforcement zones of the tunnels, such that part of the LED light sources (5) are supplied by an electrical circuit destined for the permanent illumination and another part thereof is supplied by an electrical circuit destined for the reinforcement or diurnal illumination. In this case, for example, the luminaire or lighting device (1) has a power of 150 W and is composed by multiple LED light sources (5), such that a part of these LEDs, up to a total of 5 W, are destined for the permanent illumination and are supplied by means of an individual driver or one shared with other neighboring lighting devices (1), whilst the LEDs corresponding to the balance of 145 W are destined for reinforcement illumination and are also supplied by means of an individual driver or one shared with other neighboring lighting devices (1).

By this means avoidance of having to install some lighting devices (1) for the permanent illumination and others for the reinforcement lighting is accomplished, enabling the achievement of a continuous linear design having the same lighting devices (1), they being valid for both the day and for the night in those zones wherein reinforcement lighting is required.

In the first form of preferential embodiment of the invention the LED light sources (5) present a nominal power comprised between 0 and 100 W and preferably between 0 and 50 W. Furthermore this nominal power is particularly preferably comprised between 0 and 5 W, it being such that in this form of embodiment a value of 0.5 W is specifically considered. However, the power of a LED is not a fixed value but is of a very wide variable range depending on the current supplied at a given instant, for this reason the present invention does not include operating at maximum power but at a nominal power much below the foregoing.

In addition, the aforementioned driver is utilized with the objective of increasing both the working life and the efficacy of said LED light sources (5), the power whereof must be at least that nominally required by the LEDs, in this case being 270 W for an assembly of 25 lighting devices (1) each of 2 m in length. An input voltage of between 90 and 295 V AC, an output current of 8 A and an output voltage of between 40 V DC and 54 V DC are considered. These values are variables, depending on the characteristics of both the driver and of the number of lighting devices (1) to be supplied and the number and power of the LED light sources (5) connected to the same.

For its part, the power of the driver is not a fixed value but presents a very wide variable range, this power depending at every instant of time on the supply current at every instant.

In this form of preferential embodiment of the invention each driver and the associated 25 luminaires or lighting devices (1) thereof constitute a 50 m linear lighting system having 1600 LEDs (5) through each whereof there circulates a current of 60 mA. This current is also variable as a function of the driver and the LED light sources (5) to be utilized.

In terms of example, in other forms of embodiment it may be considered that, as a function of the length of the tunnel, the driver may supply a different number of luminaires or lighting devices (1). The number of devices supplied from a single driver may vary between 1 and 100 units.

In this manner, for example, in the case of supplying 24 lighting devices (1), corresponding to a tunnel length of 48 m, the current in each LED (5) would be 62.5 mA, resulting in 4.16% more lighting in those 48 m than in the 50 m initially considered, whilst if the driver supplies 26 lighting devices (1), corresponding to a tunnel length of 52 m, the current in each LED (5) would be 57.69 mA, there being obtained 3.85% less lighting in the stretch of tunnel of 52 m than in that of 50 m.

Moreover, and returning to the form of embodiment herein proposed wherein there is considered a tunnel length of 50 m illuminated by means of 25 luminaires or lighting devices (1) supplied by the same driver, each of the lighting devices (1) comprises 64 LEDs (5) and, as a consequence, said driver is supplying a total of 1600 LEDs (5), as a result whereof the power of each of the LEDs (5) is 0.1688 W, much lower than the nominal power corresponding to said LEDs (5), by virtue thereof greater efficacy will be achieved.

Furthermore, in this example the efficacy of each luminaire or lighting device (1) is 129.94 lm/W, arising from the ratio between the light flux emitted by said lighting device (1) (1403 lm) and the power of the same (10.8 W).

In other forms of preferential embodiment of the invention this lighting efficacy presents a value varying from that obtained for this proposed form of embodiment. This variation will depend upon the light flux of the lighting device (1) and upon the power of the LED light sources (5) and, consequently, upon the lighting device (1) itself, the outcome being that the value of this luminous efficacy lies between 50 and 200 lm/W.

Below there is provided a table of the values corresponding to this example presented in terms of preferential form of embodiment of the invention:

| | LED | PCB | Lighting device | Driver |
|---|---|---|---|---|
| No. of LEDs | 1 | 16 | 64 | 1600 |
| No. of PCBs | 0.0625 | 1 | 4 | 100 |
| Length (m) | 0.031 | 0.5 | 2 | 50 |
| Current (mA) | 60 | 60 | 240 | 6000 |
| Voltage (V DC) | 2.81 | 45 | 45 | 45 |
| Power (W) | 0.1688 | 2.7 | 10.8 | 270 |
| Flux (lm) | 21.93 | 350.8 | 1403 | 35 084 |

In addition, a study has been carried out of the working life of the LED light sources (5) having a soldering temperature (Ts) of 54.5° C. and a continuous output current (If) of 120 mA, the result obtained being that solely 30% of the initial luminance is lost after 71 000 hours (>8 years).

In the form of preferential embodiment of the invention there is considered a supply of 60 mA, one half of that considered in the test and, furthermore, with lower night-time values. The fact of reducing the supply to one half significantly improves the life and efficiency of these LED light sources (5), in this case in excess of 150 000 hours (>17 years) being achieved.

It must be emphasized that the LED light sources (5) continue to be lit even though 30% of the initial luminance thereof has been lost, consequently in order to reach a point of the loss of 50% of the same one would have to wait almost 30 years in which case failures of any other component may arise beforehand, and aspects such as the reliability of the LED light sources (5) and the processes of manufacture, handling and maintenance start to be of importance.

In addition the driver or source of supply is habitually the critical element in the working life of a illumination installation having LEDs. Within the interior thereof there are located electrolytic capacitors, the life whereof greatly depends on the temperature. In this form of embodiment capacitors of 105° C. and 5000 h have been employed, this signifying that working at 50° C. (temperature within the interior of the driver) a life of 200 000 hours is achieved.

Consequently, approximately 20 years of life are obtained in the drivers by virtue of the high reliability of the condensers.

In terms of another aspect, in this example, presented as a form of preferential embodiment of the invention, the LED light sources (5) situated at adjacent extremities of consecutive luminaires or lighting devices (1) present a separation distance similar to that of two LED light sources (5) of the same lighting device (1), such that the angle of emission (AE) of light rays of the same upon the object area in the longitudinal direction of the tunnel permits a continuity of the same in the same manner as in consecutive LED light sources (5) of the same lighting device (1).

In this example, presented as a form of preferential embodiment of the invention, a symmetrical illumination by means of the continuous lighting system described is considered, however, in other forms of embodiment, the continuous lighting system may comprise means of generation of counterbeam lighting from the LED light sources (5) of a luminaire or lighting device (1), formed by a plurality of reflectors each whereof associated to one of said lighting sources.

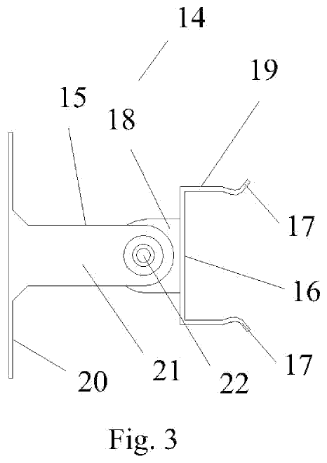

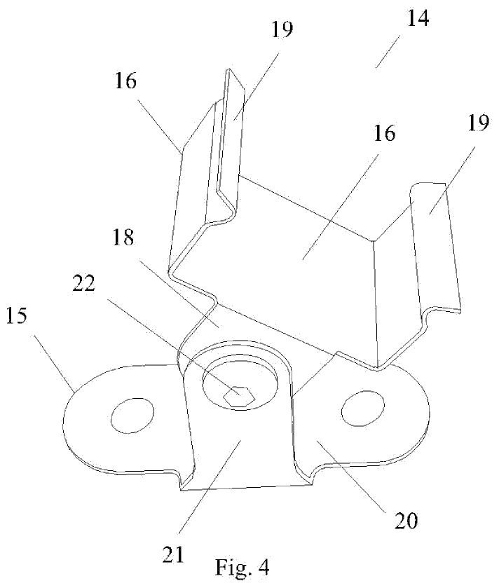

Consequently, as shown in FIGS. 3 and 4, the means of securing the longitudinal base (2) of the lighting devices (1) to the interior of the tunnel comprise at least a securing assembly (14) comprising a first part (15) formed by a planar surface (20) suitable for the securing thereof upon the wall or roof of the tunnel through bolted means, wherefrom there emerge perpendicularly the same number of parallel flanges (21) presenting a through hole of an axis of pivoting (22).

Furthermore, it comprises a second part (19) presenting a planar surface (16) wherefrom there emerge perpendicularly and in a first direction the same number of legs (17) suitable for the affixation of a base (2), and wherefrom there emerge in a second direction opposed to the first the same number of parallel flanges (18) presenting an orifice for securing the axis of pivoting (22) of the first part (15), such that the second part (19) is suitable for presenting a variation in the angle of inclination (AI) with respect to the first part (15).

The angle of inclination (AI) of the light ray in the sense of the transverse direction of the tunnel will, as a consequence, be obtained from the combination of the angle of installation of the planar surface (20) upon the wall or roof of the tunnel and the relative angle of rotation between the parts (19) and (15).

The forms of embodiment described merely constitute examples of the present invention, as a consequence the specific details, terms and phrases employed in this descriptive memorandum shall not be considered as being limitative but shall be understood merely as a basis for the claims and as a representative basis providing a comprehensible description together with the information sufficient for an expert in the matter to be enabled to apply the present invention.

1- A continuous lighting system for road tunnels comprising a plurality of luminaires or lighting devices (1) secured within the interior of the tunnel, characterized in that said lighting devices (1) are disposed in a consecutive manner and separated one from another by a distance lesser than that corresponding to the flicker frequency for the speed of traffic corresponding to the tunnel, and wherein each of the lighting devices (1) comprises
a longitudinal base (2) presenting means of securing to the interior of the tunnel,
one or more transparent or translucent elements (3) presenting first means of affixation to said base (2), the total length of the one or more closure elements (3) being coincident with the length of the base (2),
at least one printed circuit board (PCB) (4) disposed within the interior of the lighting device (1), secured to the base (2) and connected to an electrical supply network through means of connection, and,
a plurality of LED light sources (5) connected to said PCB (4) and disposed forming at least one row in the sense of the longitudinal direction of the PCB (4),
wherein said LED light sources (5) present a separation distance therebetween such that the angle of emission (AE) of light rays upon an object area in the longitudinal direction of the tunnel permits a continuity of the same for each pair of consecutive LED light sources (5) according to the same row, wherein the value of the separation distance between LED light sources (5) depends on the positioning height of the lighting device (1), and,
wherein the means of securing the base (2) to the interior of the tunnel comprise means of adjustment of an angle of inclination (AI) of the light ray in the sense of the transverse direction of the tunnel,
such that the adjustment of the angle of inclination (AI) in combination with the angle of emission (AE) permits a lighting of the object area having a longitudinal uniformity approaching 100%.

2- A continuous lighting system for road tunnels as claimed in claim 1, characterized in that the one or more transparent or translucent closure elements (3) is formed by a lens having optical functionality disposed over a plurality of LED light sources (5).

3- A continuous lighting system for road tunnels as claimed in claim 1, characterized in that the lighting device (1) comprises within the interior thereof at least one lens (9) having optical functionality disposed over at least one LED light source (5) and presenting second means of affixation to the base (2).

4- A continuous lighting system for road tunnels as claimed in claim 3, characterized in that it comprises at least two lenses (9) having optical functionality and at least one thereof presents an optical functionality differing from that of the other lenses (9).

5- A continuous lighting system for road tunnels as claimed in any of the foregoing claims, characterized in that the means of connection of the at least one PCB (4) to the electrical network of supply of alternating current includes means of supply of direct current to the same and means of regulation of the current and/or the voltage of the direct current supplied to the LED light sources (5).

6- A continuous lighting system for road tunnels as claimed in claim 5, characterized in that the means of supply of current and the means of regulation of the current and/or the voltage of the LED light sources (5) of a lighting device (1) comprises at least one driver.

7- A continuous lighting system for road tunnels as claimed in claim 6, characterized in that the LED light sources (5) of a lighting device (1) are connected to at least two drivers disposed in parallel.

8- A continuous lighting system for road tunnels as claimed in claim 7, characterized in that the LED light sources (5) of a lighting device (1) are configured according to at least two groups, wherein each of these groups is supplied by a different electrical circuit.

9- A continuous lighting system for road tunnels as claimed in any of the foregoing claims, characterized in that the object area is a carriageway or a part thereof and the lighting devices (1) secured to the interior of the tunnel are secured upon the walls or the roof of the same.

10- A continuous lighting system for road tunnels as claimed in any of the foregoing claims, characterized in that the LED light sources (5) situated in adjacent extremities of two consecutive lighting devices (1) present a separation distance similar to the distance existing between two LED light sources (5) of the same lighting device (1), such that the angle of emission (AE) of light rays of the same upon an object area in the longitudinal direction of the tunnel permits a continuity of the same in the same manner as in consecutive LED light sources (5) of the same lighting device (1).

11- A continuous lighting system for road tunnels as claimed in any of the foregoing claims, characterized in that the extremities of the longitudinal base (2) present a lateral closure (8) of the lighting device (1) comprising a leadout part (13) of a cable of connection of the at least one PCB (4) at both extremities.

12- A continuous lighting system for road tunnels as claimed in any of the foregoing claims, characterized in that the lighting device (1) comprises within the interior thereof at least two PCBs (4) and the latter are connected in parallel.

13- A continuous lighting system for road tunnels as claimed in any of the foregoing claims, characterized in that it comprises means of generation of counterbeam lighting from one or several of the LED light sources (5) of a lighting device (1) formed by a plurality of reflectors each thereof associated with the one or several of said LED light sources (5).

14- A continuous lighting system for road tunnels as claimed in any of the foregoing claims, characterized in that the base (2) is formed by a longitudinal extrusion of aluminum.

15- A continuous lighting system for road tunnels as claimed in any of the foregoing claims, characterized in that the means of securing the longitudinal base (2) to the interior of the tunnel comprise at least a securing assembly (14) comprising a first part (15) formed by a planar surface (20) suitable for the securing thereof upon the wall or roof of the tunnel through bolted means, wherefrom there emerge perpendicularly the same number of parallel flanges (21) presenting a through hole of an axis of pivoting (22), and a second part (19) presenting a planar surface (16) wherefrom there emerge perpendicularly and in a first direction the same number of legs (17) suitable for the affixation of a base (2), and wherefrom there emerge in a second direction opposed to the first same number of parallel flanges (18) presenting an orifice for securing the axis of pivoting (22) of the first part (15), such that the second part (19) is suitable for presenting a variation in the angle of inclination (AI) with respect to the first part (15).

16- A continuous lighting system for road tunnels as claimed in claim 15, characterized in that the angle of inclination (AI) of the light ray in the sense of the transverse direction of the tunnel is obtained by means of the combination of the angle of installation of the planar surface (20) upon the wall or roof of the tunnel and the relative angle of rotation between the second part (19) and the first part (15) of the securing assembly (14).
